(19) United States
(12) Patent Application Publication
(10) Pub. No.: US 2012/0330780 A1
(43) Pub. Date: Dec. 27, 2012

(54) Electronic Window For Placing A Personalized Service Over A Communication Network

(76) Inventors: Ashish Saxena, New Delhi (IN); Rahul Kumar Gupta, Uttar Pradesh (IN)

(21) Appl. No.: 13/359,688

(22) Filed: Jan. 27, 2012

(30) Foreign Application Priority Data
Jun. 8, 2011 (IN) 1944/CHE/2011

(51) Int. Cl. G06Q 30/00

(52) U.S. Cl. 705/26.8

(57) ABSTRACT

According to the present disclosure an electronic window is provided to provide a personalized service over a communication network whereby a registered user is connected with a vendor/dealer with an ability for a vendor to push his/her products/services with a user in his/her database to be able a product/service using user's mobile phone or e-mail message.

### CLAIM OF PRIORITY

This application claims priority under 35 USC §119 to Indian Patent Application No. 1944/CHE/2011, filed on Jun. 8, 2011, the entire contents of which are hereby incorporated by reference.

### TECHNICAL FIELD

Embodiments of the present disclosure relate to an electronic ordering system, and more specifically to, an electronic window that provides a personalized service over a communication network by means of a short-text-message or an email message.

### BACKGROUND

Currently, the ordering and sale of goods and services is commonly done via Internet. The providers of the goods construct Web sites, and those who wish to purchase these goods electronically visit various kinds of Web sites and select the goods to be purchased.

Also, business to business platforms utilizing the Internet have been gradually realized. These are developed mainly for the procurement of material directly used in the business and production activities.

Unfortunately, it is difficult for a user himself/herself who wishes to obtain the item to perform the ordering process himself. There is no technique through which a user can be connected with a vendor/ecommerce shop with an ability for a vendor to push his/her product/services with a user in his/her database to be able to order a product/service using a user's mobile phone or through an email-message directly.

Namely, a provider may send promotions via regular personalized e-mail campaigns or mobile marketing campaigns to his/her registered customers on a regular basis which entices the customer to log into the website, to avail the promotion and order online.

In another case, when a registered user visits provider's Web Site and for some reasons he/she may abandon the shopping cart without completing the order. Then the next step for the provider company for such customers is to send them an e-mail and try to entice them to go back to the website and complete the transaction.

In another case, when a registered customer adds items to his/her wish list on the provider's website, normally, the user receives information regarding the items on the wish list via e-mails or sms on a regular basis from the provider and is pushed back to go the website to view the details of the products, thereby, subsequently ordering the item on line over the web.

In another case, even the registered user is aware of the product ID and other details of the product they want to buy as the product cannot be bought without visiting to the online over the web.

Hence, there is a need for an indirect business in charge of placing a personalized service, by promoting the items directly on the registered user terminal device and at the same time also allowing the user to purchase the item without accessing the promoter's website.

Accordingly, there is a clear need for an improved method and system for making purchase orders.

### SUMMARY

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

It is general object of the present disclosure to provide a personalized service to the registered user by connecting the user with a vendor/dealer with an ability for a vendor/dealer to push his/her products/services with a user in his/her database to be able to order a product/service using user's mobile phone and/or email message.

A related object of the present disclosure is to provide a methodology for converting abandoned shopping carts into orders.

Another object of the present disclosure is to allow registered users to buy products/services directly from his/her e-mail and phone using an e-mail message and/or a short-text message.

Briefly, the present disclosure discloses an electronic window for providing a personalized service over a communication network, comprising: at least one processor coupled to a network; a memory coupled to the processor, the memory including a database and instructions adapted to be executed by the processor; wherein said processor comprises: an item promotion component configured to promote ordering of items from promotion of a plurality of items as displayed on the registered user's terminal device and that allows the plurality of different items to access a wish list component on the user's terminal device and to place one or more items corresponding to the wish list component; a validation component that validates the registered user, an abandoned order, or a new order made by a registered user; a renewal component that allows a registered user to renew its abandon order for one or more items corresponding to the wish list component; and an ordering component that allows ordering of the selected items from the promotion of a plurality of items corresponding to the wish list component placed by means of a short-text-message and/or an email message.

Another embodiment of the present disclosure discloses a method of ordering of items, said method comprising: promoting ordering of items from promotion of a plurality of items over the network to a registered user's terminal device and that allows the plurality of different items to access a wish list component on the user's terminal device to place one or more items corresponding to the wish list component; validating the registered user, abandoned order by a registered user, or any new order made by a registered user; renewing an abandon order of a registered user for one or more items; and ordering of the selected items from the promotion of a plurality of items over the network and that allows purchasing of items corresponding to the wish list component by the plurality of different items by means of a short-text-message and/or an email message.

Another embodiment of the present disclosure discloses a computer-readable medium having executable instructions to cause a machine to perform a method for electronically ordering items, the method comprising: promoting ordering of items from promotion of a plurality of items over the network on a registered user's terminal device and that allows the plurality of different items to access a wish list component on the user's terminal device to place one or more items corresponding to the wish list component; validating the registered user, abandoned order by a registered user, or any new order made by a registered user; a renewing an abandon order of a registered user for one or more items; and ordering of the selected items from the promotion of a plurality of items over the network and that allows purchasing of items corresponding to the wish list component by the plurality of different items by means of a short-text-message and/or an email message.

These and other objects, embodiments and advantages of the present disclosure will become readily apparent to those skilled in the art from the following detailed description of the embodiments having reference to the attached figures, the disclosure not being limited to any particular embodiments disclosed.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates a block diagram showing a configuration of an embodiment according to the present disclosure.

FIG. 2 illustrates an explanatory chart showing the relationship between the electronic window used in the configuration shown in FIG. 1 and a customer's purchasing unit (group of users).

FIG. 3 illustrates a flow chart showing an example of the order issuing/receiving process in the configuration shown in FIG. 1 according to an embodiment of the present disclosure.

Like reference symbols in the various drawings indicate like elements.

### DETAILED DESCRIPTION

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures. It should be appreciated that the functions, structures, elements and the protocols used in communication are irrelevant to the present disclosure. Therefore, they need not be discussed in more detail here.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

The features provided by the disclosed system in the present disclosure may be accessed remotely, in one or more embodiments, and/or through an online service provider. Such types of online service providers operates and maintains the computing systems and environment, such as server system and architectures, that promote the delivery of portable electronic documents in a communication network. Typically, server architecture includes the infrastructure (e.g., hardware, software, and communication lines) that offers online services.

The detailed description follows in parts to terms of processes and symbolic representations of operations performed by conventional computers, including computer components. For the purpose of this disclosure, a computer may be any microprocessor or processor (hereinafter referred to as processor) controlled device such as, by way of example, personal computers, workstations, servers, clients, minicomputers, main-frame computers, laptop computers, a network of one or more computers, mobile computers, portable computers, handheld computers, palm top computers, set-top boxes for a TV, interactive televisions, interactive kiosks, personal digital assistants, interactive wireless devices, mobile browsers, or any combination thereof.

For the most part, the operations described herein are operations performed by a computer or a machine in conjunction with a human operator or user that interacts with the computer or the machine. The programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein.

Those having ordinary skill in this art will appreciate that the items mentioned herein refers to the products and services promoted by the vendor/dealer.

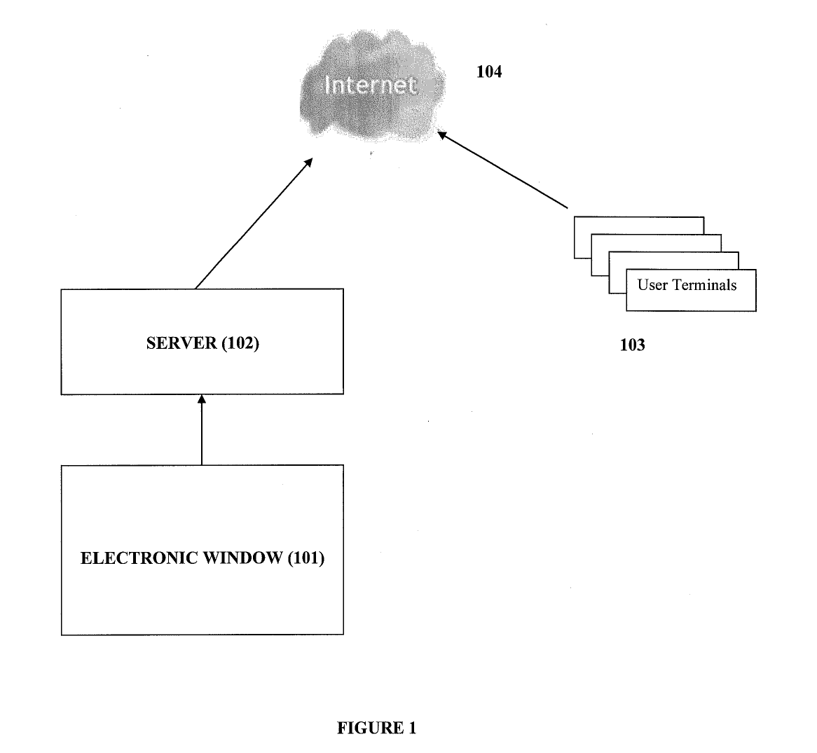

FIG. 1 illustrates a block diagram showing the configuration of an embodiment of the present disclosure. According to the present embodiment is equipped with an electronic window 101 connected to a server 102 which is further connected to a plurality of user terminal 103 via a network 104, such as the Internet or Telecommunication Channel. In the configuration of the present embodiment, issuing/receiving orders between a plurality of customers (customer management units) and a plurality of dealers can be executed on a single server. The server is equipped with an item specific ordering controller which, when an order request for ordering one or more items is received from a terminal used by a user who belongs to a purchasing unit, specifies a dealer offering each item in the ordering request based on the item promotion related information specific to the purchasing unit to which the user belongs.

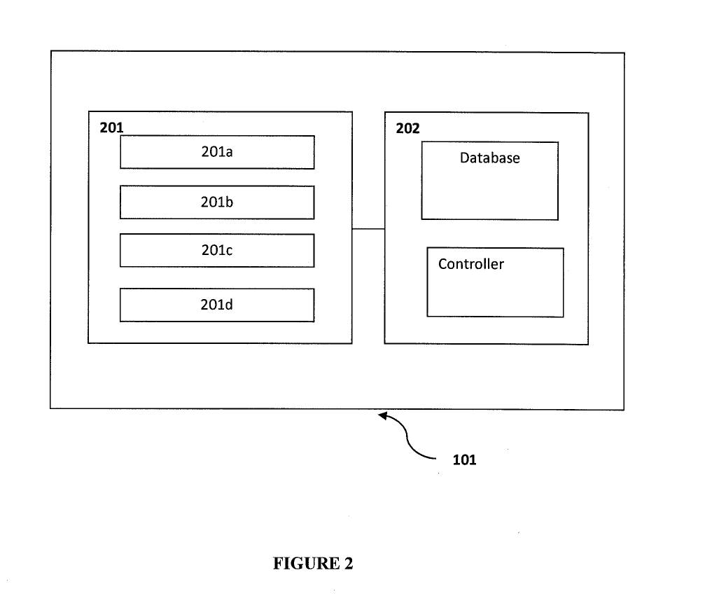

FIG. 2 illustrates an internal configuration of the electronic window according to the present disclosure. The Electronic Window 101 comprises at least a processor 201 and a memory 202 coupled to the processor 201. The memory includes a database and Controller to provide control instructions adapted to be executed by the processor.

Further, the processor 201 comprises an item promotion component 201a configured to promote ordering of items from promotion of a plurality of items as displayed on the registered user's terminal device and that allows the plurality of different items to access a wish list component 201e on the user's terminal device and to place one or more items corresponding to the wish list component; a validation component 201b that validates the registered user, an abandoned order, or a new order made by a registered user; a renewal component 201c that allows a registered user to renew its abandon order for one or more items corresponding to the wish list component; and an ordering component 201d that allows ordering of the selected items from the promotion of a plurality of items corresponding to the wish list component placed by means of a short-text-message and/or an email message.

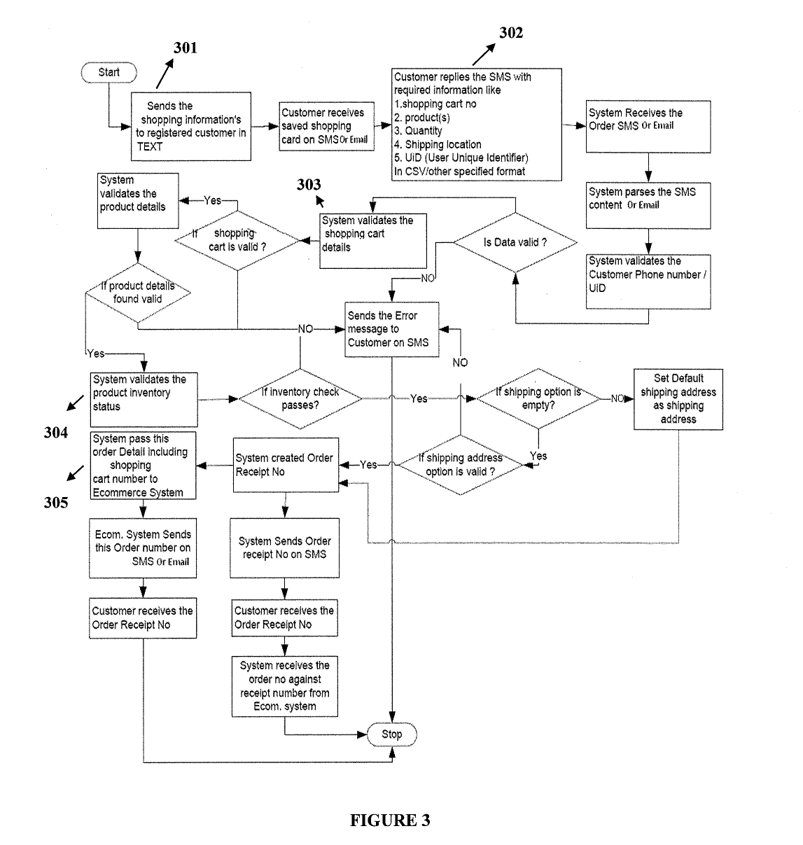

FIG. 3 illustrates the workflow states for making new order or renewing abandon order according to an embodiment of the present disclosure. As shown in the flowchart new promotions or abandon shopping information is sent to registered user (or customer) via email message or a short-text message (sms) on the user terminal device (i.e., mobile, laptop, ipod etc.) as given in Step 301. The Customer replies to the SMS or E-Mail with the required information such as shopping cart number, the product detail, quantity, shipping location and the user identifiers (i.e., mobile phone number or email address) as given in Step 302.

Step 303, validates the registered user, new order or an abandon order by means of the validation component.

Step 304 allows a registered user to renew its abandon order for one or more items corresponding to the wish list component by means of renewal component.

Step 305 that allows ordering of the selected items from the promotion of a plurality of items corresponding to the wish list component placed by means of a short-text-message and/or an email message. Further, instead of ordering separately by each dealer, group ordering separated by each approval standard can be performed.

It may be better arranged so that each group of order items is temporarily stored using a shopping cart function commonly used, for example, on sales sites on the Internet.

In the preferred embodiment, the database memorizes various kinds of items/products with their products identifiers i.e., their respective IDs. These information related to items of goods or services, and a server 102 which is connected to a user terminal via a network such as the Internet, controls data sending/receiving with the user terminal, and extracts or stores data of various kinds of vendors, an order issuing function is provided to terminals of one or more users who belong to the customer's purchasing unit, and also an order receiving function is provided to terminals of a plurality of dealers who offer items identified by item numbers to the customer. Each user terminal displays a page sent from the server and sends various kinds of requests to the server 102 according to operation of links in the page and an execute button.

In the exemplary embodiment, the server 102 sends a page described in a mark-up language such as HTML and XML to each of the plurality of terminals, according to data input via the page or operation of an execute button etc. on the page, data stored in various kinds of items are searched and a page is generated, and by sending this generated page to the terminal, various kinds of functions are offered to each of the terminals. Each terminal only needs to have a communication control function that controls communication with the server 102 and a user function that interprets a specified mark-up language and displays it, which can realize on the terminal via communication with the server 102 the same function as in the case when the application software is installed on each terminal.

In a further embodiment, the electronic window allows the vendor's/dealers to reach out to their existing customers who have abandoned his/her shopping cart, created wishlists/saved carts etc. These set of users will be approached directly using e-mail and/or sms with an ability to complete the transaction quickly without having the need to visit the web site again. This request can be initiated by a user's laptop, desktop, ipod, mobile devices etc. This brings ease of use for the customers and provides an opportunity to the vendors/dealers to be able to decrease the ever increasing abandoned shopping cart rate.

According to the present invention, abovementioned methodology take care of managing changes in the compliance definition and enables to perform impact analysis and reporting based on revised compliance definition.

The present disclosure is applicable to all types of on-chip and off chip memories used in various in digital electronic circuitry, or in hardware, firmware, or in computer hardware, firmware, software, or in combination thereof. Apparatus of the invention can be implemented in a computer program product tangibly embodied in a machine-readable storage device for execution by a programmable processor; and methods actions can be performed by a programmable processor executing a program of instructions to perform functions of the invention by operating on input data and generating output. The invention can be implemented advantageously on a programmable system including at least one input device, and at least one output device. Each computer program can be implemented in a high-level procedural or object-oriented programming language or in assembly or machine language, if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data file; such devices include magnetic disks and cards, such as internal hard disks, and removable disks and cards; magneto-optical disks; and optical disks. Storage devices suitable for tangibly embodying computer program instructions and data include all forms of volatile and non-volatile memory, including by way of example semiconductor memory devices, such as EPROM, EEPROM, and flash memory devices; magnetic disks such as internal hard disks and removable disks; magneto-optical disks; CD-ROM and DVD-ROM disks; and buffer circuits such as latches and/or flip flops. Any of the foregoing can be supplemented by, or incorporated in ASICs (application-specific integrated circuits), FPGAs (field-programmable gate arrays) and/or DSPs (digital signal processors).

It will be apparent to those having ordinary skill in this art that various modifications and variations may be made to the embodiments disclosed herein, consistent with the present disclosure, without departing from the spirit and scope of the present disclosure. Other embodiments consistent with the present disclosure will become apparent from consideration of the specification and the practice of the description disclosed herein.

A number of embodiments of the invention have been described. Nevertheless, it will be understood that various modifications may be made without departing from the spirit and scope of the invention.

What is claimed is:

1. An electronic window for providing a personalized service over a communication network, comprising:
at least one processor coupled to a network;
a memory coupled to the processor, the memory including a database and instructions adapted to be executed by the processor;
wherein said processor comprises:
an item promotion component configured to promote ordering of items from promotion of a plurality of items as displayed on the registered user's terminal device and that allows the plurality of different items to access a wish list component on the user's terminal device and to place one or more items corresponding to the wish list component;
a validation component that validates the registered user, an abandoned order, or a new order made by a registered user;
a renewal component that allows a registered user to renew its abandon order for one or more items corresponding to the wish list component; and
an ordering component that allows ordering of the selected items from the promotion of a plurality of items corresponding to the wish list component placed by means of a short-text-message and/or an email message.

2. The electronic window of claim 1, wherein the wish list component comprises the items selected by the registered user.

3. The electronic window of claim 1, wherein the user terminal device is identified by a mobile telephone number of the user.

4. The electronic window of claim 1, wherein the said user terminal device is identified by an email address of the user.

5. The electronic window of claim 1, wherein the items promoted have a common schema associated with descriptions of the items.

6. The electronic window of claim 1, wherein the window is implemented at least in part by an application programming interface.

7. A method of ordering of items, said method comprising:
promoting ordering of items from promotion of a plurality of items over a network to a registered user's terminal device and that allows the plurality of different items to access a wish list component on the user's terminal device to place one or more items corresponding to the wish list component;
validating the registered user, abandoned order by a registered user, or any new order made by a registered use;
renewing an abandon order of a registered user for one or more items; and
ordering of the selected items from the promotion of a plurality of items from promotion of a plurality of items over the network and that allows purchasing of items corresponding to the wish list component by the plurality of different items by means of a short-text-message and/or an email message.

8. The method of claim 6, wherein the wish list component comprises the items selected by the registered user.

9. The method of claim 6, wherein the user terminal device is identified by a mobile telephone number of the user.

10. The method of claim 6, wherein the user terminal device is identified by an email address of the user.

11. The method of claim 6, wherein the items promoted have a common schema associated with descriptions of the items.

12. The method of claim 6, wherein the window is implemented at least in part by an application programming interface.

13. A computer-readable medium having executable instructions to cause a machine to perform a method for electronically ordering items, the method comprising:
promoting ordering of items from promotion of a plurality of items over the network to a registered user's terminal device and that allows the plurality of different items to access a wish list component on the user's terminal device to place one or more items corresponding to the wish list component;
validating the registered user, abandoned order by a registered user, or any new order made by a registered use;
renewing an abandon order of a registered user for one or more items; and
ordering of the selected items from the promotion of a plurality of items over the network and that allows purchasing of items corresponding to the wish list component by the plurality of different items by means of a short-text-message and/or an email message.

14. The computer-readable medium of claim 12, wherein the wish list component comprises the items selected by the registered user.

15. The computer-readable medium of claim 6, wherein the user terminal device is identified by a mobile telephone number of the user.

16. The computer-readable medium of claim 6, wherein the user terminal device is identified by an email address of the user.

17. The computer-readable medium of claim 6, wherein the items promoted have a common schema associated with descriptions of the items.

18. The method of claim 6, wherein the window is implemented at least in part by an application programming interface.
